(19) United States
(12) Patent Application Publication
(10) Pub. No.: US 2011/0231497 A1
(43) Pub. Date: Sep. 22, 2011

(54) SYSTEMS AND METHODS FOR MONITORING AND NOTIFICATION OF ACCESS AND USE OF THE INTERNET

(76) Inventor: Tom C. Tovar, San Francisco, CA (US)

(21) Appl. No.: 12/897,653

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 15/173; G06F 15/16

(52) U.S. Cl. 709/206; 709/224; 709/245

(57) ABSTRACT

Systems and methods for providing notifications are provided. Information regarding Internet content is received. A determination by an Internet service or a DNS server is made as to whether the Internet content has been accessed by a second end user. A notification is generated and transmitted when the Internet content has been accessed.

### CROSS REFERENCES TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to monitoring and notification of Internet use. The invention relates more particularly to systems and methods for providing carrying out the monitoring and providing notifications regarding Internet access and use.

### SUMMARY OF THE INVENTION

Various embodiments of the present invention provide systems and methods for user defined notifications regarding Internet access and use on the home network or from designated access devices. Such systems and methods are powerful tools for certain groups of users. For instance, parents who wish to obtain insight into their children's Internet usage to make more informed parenting choices may benefit from the present technology. They may wish to be notified when their children use or access certain Internet content, including access within a content category or for a specific site or sites selected by the parent. It will be appreciated by those skilled in the art that any type of user (not just parents) may utilize this technology to monitor another user's use of Internet content on the home network or personal devices.

It will be noted that as used herein the term Internet content encompasses any website, web service or other content or service presented to a user on the Internet or through a user device. The term web content is used herein to refer to any Internet content generated or accessed by or through a web browser.

In accordance to some embodiments of the present technology, an exemplary method for providing notifications regarding Internet access and use includes several steps. Information regarding Internet content is selected by the first user as Internet content to be monitored and reported on. Access attempts and usage information regarding such Internet content is received via a user interface between any end user and the Internet service. Further, the exemplary method may include determining whether the Internet content has been selected as content to be monitored and reported upon and whether such content has been accessed or used, thereby generating a notification, and transmitting the generated notification via a user interface to the first user. The determination step may be performed by the Internet service. In some embodiments, the Internet service may be coupled to the Internet service provider. The notification can be made in any form, including email, embedded message within the Internet service, text message, or other forms as designated by the user.

An exemplary system for providing notifications regarding Internet access and use may include the Internet service and a user interface between any end user and the Internet service that allows the first user to select what Internet content is to be monitored by the Internet service. The user interface may operate between an end user and an Internet service provider. For purposes of this disclosure, the definition of Internet service provider will include any service or technology that provides a connection to the Internet. Examples of such technologies include, but are not limited to, traditional Internet service providers (ISPs), telecommunications companies, cable operators, mobile operators, network operators and any other provider of wired or wireless access to Internet services. The system may be set up to utilize a DNS (Domain Name System) server or a cloud based networking system.

The exemplary system for providing notifications may further include a processor for executing the instructions stored in memory to: determine whether the Internet content has been accessed by an end user, the determination performed by the Internet service, generate a notification when the Internet content has been accessed by the second end user, and transmit the generated notification via the user interface to the first end user.

The exemplary system may be a stand-alone application or be provided as part of a system of one or more policy applications (including but not limited to a notification policy application) that allow the first end user to selectively determine the specific portion of the Internet received or accessed by an end user, including any end user within a network, with all end users being monitored by the system. The policy applications may be discrete applications and may be single purpose applications. The applications may be configured to meet the needs, rules and behaviors desired by the first user. The first user may select one or more policy applications from a selection menu to provide an individualized Internet experience for the end user or his household.

The end user selects the policy applications that he wants to apply to his Internet service. The selections are made using at least one of the Internet access devices available to the user and the user interface. The policies contained in the policy applications are applied to the Internet service that is supplied to the end user. Policies may include specific sites that can or cannot be accessed. Policies may also include time and duration of access, and limitations and restrictions specific to a given user or to the home or other network generally. It should be noted that the policy applications may be used to not only prohibit undesired behaviors, but may also be used to encourage desired behaviors. Other users within a home network may be redirected to sites other than those chosen based on a policy application applied by the user.

Information about the notifications and/or notification settings of an end user may be shared by the first user with third parties. An end user may publish to friends or other third parties the notification policy applications they are using, and/or which policies he has in place. Similarly, the end user may access information from third parties, such as which notification policies they are using, which notification policy applications they find useful, etc.

The user interface may be accessed though a gateway available to the end user. Gateways include but are not limited to desktops, PCs, laptops, notebooks, game consoles (e.g., an X-box), music players, tablets, IPods, Smartphones, automobile computer systems, and Internet enabled TVs. A Smartphone may be generally defined as a phone with computing capability. A Smartphone may provide Internet access to an end user.

### BRIEF DESCRIPTION OF THE DRAWINGS

FIG. 1 is a flow chart of an exemplary method for providing notifications regarding Internet access in accordance with various embodiments of the present invention.

FIG. 2 is a block diagram of an exemplary environment for providing notifications regarding Internet access in accordance with various embodiments of the present invention.

FIG. 3 is an exemplary screenshot regarding a notification policy application in accordance with various embodiments of the present invention.

FIG. 4 is an exemplary screenshot showing a user interface associated with a notification policy application in accordance with various embodiments of the present invention.

FIG. 5 is a block diagram of a DNS server arrangement in accordance with various embodiments of the present invention.

FIG. 6 is a block diagram of an exemplary system for providing variable content control for Internet users in accordance with various embodiments of the present invention.

FIG. 7 is a block diagram of an exemplary system for providing notifications regarding Internet access in accordance with various embodiments of the present invention.

### DETAILED DESCRIPTION

Various embodiments of the present invention provide a method and system for providing notifications regarding Internet access and use. A first end user may wish to be notified when another user has accessed, attempted to access or used particular Internet content or Internet content within a category that was selected by the first end user. An exemplary system for providing notifications regarding Internet access and use may include an Internet service coupled to an Internet service provider and a user interface between the first end user and an Internet service provider that allows the first end user to select which Internet content is to be monitored. The exemplary system for providing notifications may further include a processor for executing the instructions stored in memory to: determine whether the Internet content has been accessed by a second end user, the determination performed by the DNS server or Internet service, including a combination thereof; generate a notification when the Internet content has been accessed or used; and transmit the generated notification via the user interface to the first end user.

Generally speaking, an administrator may create and enforce mediation polices for one or more end users that utilize computing devices coupled to an Internet service delivered to a location such as a home, residence or place of business or campus. The term “administrator” may include not only individuals, such as parents, but also any individual creating a mediation policies regarding the Internet service delivered to end users. It will be understood that an administrator may also be an end user, although end users who are not also administrators may not create or apply policies.

Exemplary user devices for use with the disclosed systems may have an app. As used herein, an app shall be defined as a module including a user interface to an Internet service. The app may further include one or modules included in the Internet service. An app may be downloaded and installed on a user's computing device, including mobile devices. Users may define mediation policy via a user device, such as through the user interface. Some embodiments of the present invention do not require software to be downloaded or installed locally to the user device and, accordingly, do not require the user to execute a de-install application to cease use of the system.

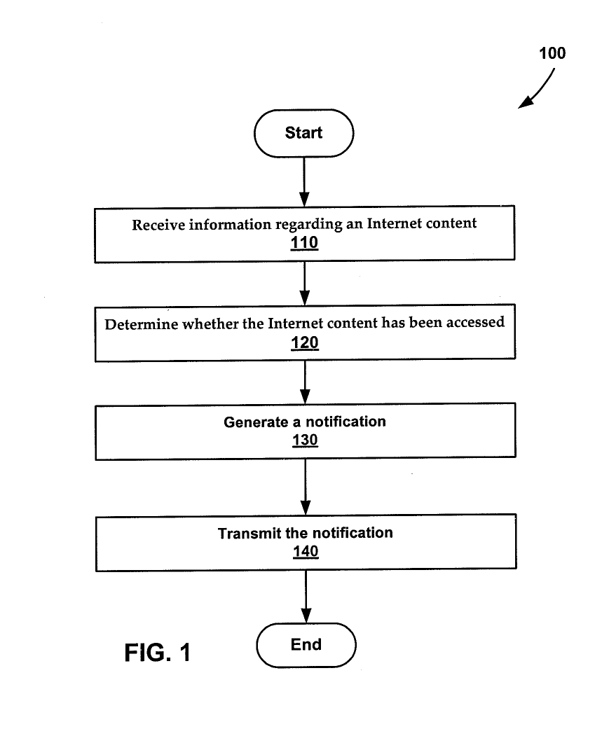

FIG. 1 is a flowchart of an exemplary method 100 for providing notifications regarding Internet access. At step 110 of the method 100 information regarding Internet content is received by an Internet service via a user interface between an first end user and the Internet service. The user interface may be accessible by one or more user devices operated by the first end user. The DNS server may be coupled to the Internet service.

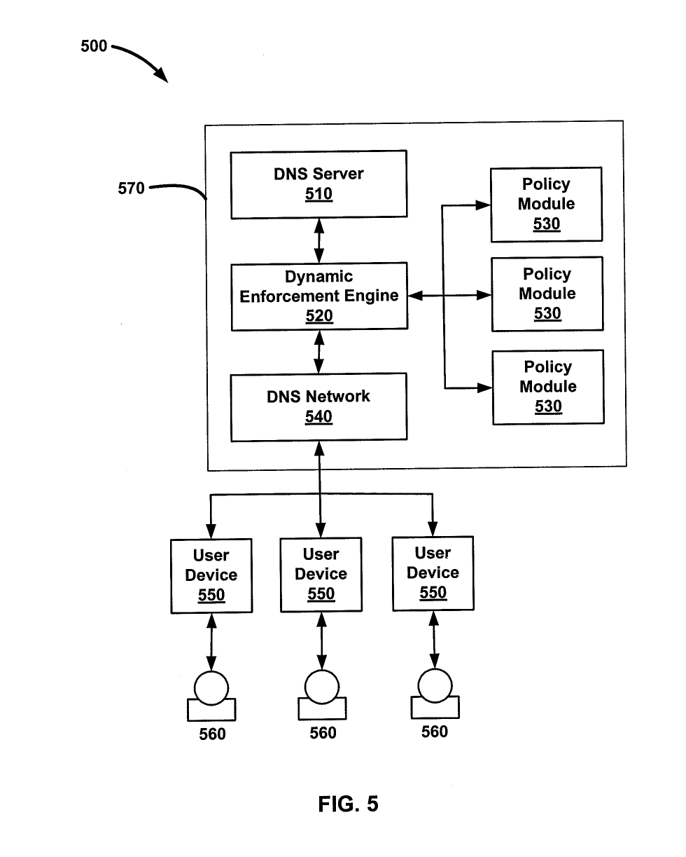

Internet content may be specific web content, such as a website, or be associated with a category of Internet content selected by the first end user. The information received regarding the Internet content at step 110 may comprise a company name associated with the Internet content, a site name associated with the Internet content, a category name associated with the Internet content, or any combination thereof. The user interface may allow a first end user to select which Internet content is to be monitored by the Internet service. The user interface may operate between any end user and the Internet service. User devices (such as user devices 550 of FIG. 5) may comprise various computing devices. If remote control of the method is desired, a portable computing device such as a Smartphone may be utilized as the control device to enable, disable or configure the Internet service. In this scenario, operating applications may reside on the user device 550. It may also be understood that in some embodiments, the first end user and the other end user may be the same user.

At step 120, a determination is made whether the Internet content specified by the first end user has been accessed or used by a second end user. The determination in step 120 may be performed by the Internet service which may, in turn, utilize a DNS server (such as the DNS server 510 of FIG. 5). Determining whether the Internet content has been accessed or used by the second end user may comprise receiving from the Internet service or the DNS server a list of Internet content or domains that are accessed by the second end user. According to various embodiments, the list of Internet content accessed by the second end user may be compared against a list of Internet content being monitored, such comparison may be performed by the DNS server via a query to the Internet service. Such a list of Internet content being monitored may be called a monitoring list. In various embodiments, determining whether the Internet content has been accessed by the second end user may further comprise receiving access information regarding a monitored Internet content from a third party.

If the Internet content designated to be monitored by the first end user is accessed by the second end user, at step 130, a record of that access attempt may be stored in the Internet service and a notification may be generated to the first end user. The format of the notification may be determined during this step. In various embodiments of the present technology, the generated notification may include the identification of the Internet content that was accessed, as well as the date and time it was accessed. It may be appreciated that any engine, module, server, database, or any combination thereof may help to generate the notification.

At step 140, the generated notification is transmitted to the first end user. In some embodiments, the notification is transmitted to display on a user device of the first end user via a user interface. In further embodiments, the notification is transmitted through electronic mail or text messages to display for the first end user. At step 140, the generated notification may optionally be transmitted to a third party (such as a social networking Internet content, a community, a third party Internet content, or any computing device or user that is not serviced by the Internet service provider that services the first and second end users).

The method 100 may include one or more optional steps. For instance, the method 100 may include the step of storing the received information regarding the Internet content in memory. Any type of storage memory may be utilized. The method 100 may also include determining and/or otherwise identifying Internet content associated with a given category. If an end user inputs a category instead of information of a specified Internet content, a monitoring list may become pre-populated with one or more Internet content associated with the category. The monitoring list may be displayed on a user interface that is provided to the first end user. The Internet service and/or a database associated with the Internet service may provide Internet content that is associated with categories or category names selected by the first user. The monitoring list may be modified by the first end user. For instance, the method 100 allows for the receipt and implementation of feedback regarding the monitoring list from an end user. For example, if an end user disagrees with the Internet content(s) determined by the Internet service as being related to the category requested by the end user, the end user may reject one or more of the Internet content(s) or may select from another menu of suggested Internet content(s) deemed by the Internet service as being closely related or aligned to the end user's request. Further, the monitoring list may be created leveraging the social production from among several users of the Internet service and imported into the Internet service of the first user. The user generated monitoring list may also be modified and republished by the first end user for collaboration with other users of the Internet service until the first user accepts the monitoring list for his home network or devices designated by the first user.

The monitoring list may also include Internet content collaboratively determined by a group of end users invited by an administrator to collaborate on the establishment of the Internet content records used in the mediation policy. The administrator may, before or after the administrator creates the administrator's own monitoring list, invite the administrator's family members, friends, colleagues or any group of combination of groups and individuals to identify Internet content to be used by the administrator in creating the administrator's own monitoring list. These invitees may or may not be users of the Internet service but will be allowed to contribute to the administrator's monitoring list via the user interface of the Internet service. The administrator may choose to moderate the contributions of individuals or groups invited by the administrator to contribute to the administrator's monitoring list. The administrator may also, before or after the administrator creates the administrator's own monitoring list, join an existing group of users of the Internet service and apply the determinations of appropriate Internet content by a group to the administrator's own monitoring list. Where there is an existing group that the administrator joins for purposes of creating a monitoring list, the administrator may choose to import the contributions of other groups once or subscribe to these groups to reduce the configuration burden of creating a monitoring list. After the administrator creates the administrator's own monitoring list, the administrator may publish the administrator's monitoring list to be used and/or subscribed to by other users of the Internet service. In such case, other users of the Internet service may import the contributions of administrator once or subscribe to the administrator's monitoring list for use in their own mediation policies. It is understood that via this collaboration two or more user-administrators may combine their monitoring lists to create one mediation policy that may be used by these and other administrators of the Internet service.

The method 100 may further include the optional step (not shown) of providing one or more policy applications 620. The policy applications 620 may be discrete, single purpose applications, such as a notification policy application as described herein. Using single purpose policy applications 620 may make the applications more straightforward and easier for the end users 160 to operate.

The method 100 may also include the optional step of pre-populating the monitoring list with Internet content that is associated with the category. The monitoring list may be displayed on a user interface that is provided to the first end user.

For a notification policy application, the method 100 may also include the optional step of applying policies of a notification policy application to the Internet service provider. In this optional step, logging and reporting Internet access of the Internet content may be performed with the help of the Internet service. With the help of the Internet service, the method 100 may include an optional access data collection step (not shown). The method 100 may collect whatever access data is desired. Possible collected data may include but is not limited to use characteristics such as sites visited, number of visits to each site, duration of visits, days and times of visits, etc. Data may also be collected and catalogued by individual end user (such as the end user 160 in FIG. 1) of the method 100. At least one end user may be designated to receive the data collected. The end user designated to receive collected data may be the same user authorized to establish the policy protocol of the method 100.

In an optional sharing step (not shown), an end user of the method 100 may transmit, share, or publish information regarding an Internet content with a third party at the discretion of the end user. Typical information regarding an Internet content that is transmitted, shared or published may be specific sites being monitored or tracked, categories of Internet content being monitored or tracked, policy applications 620 being used, and other uses and characteristics of the method 100.

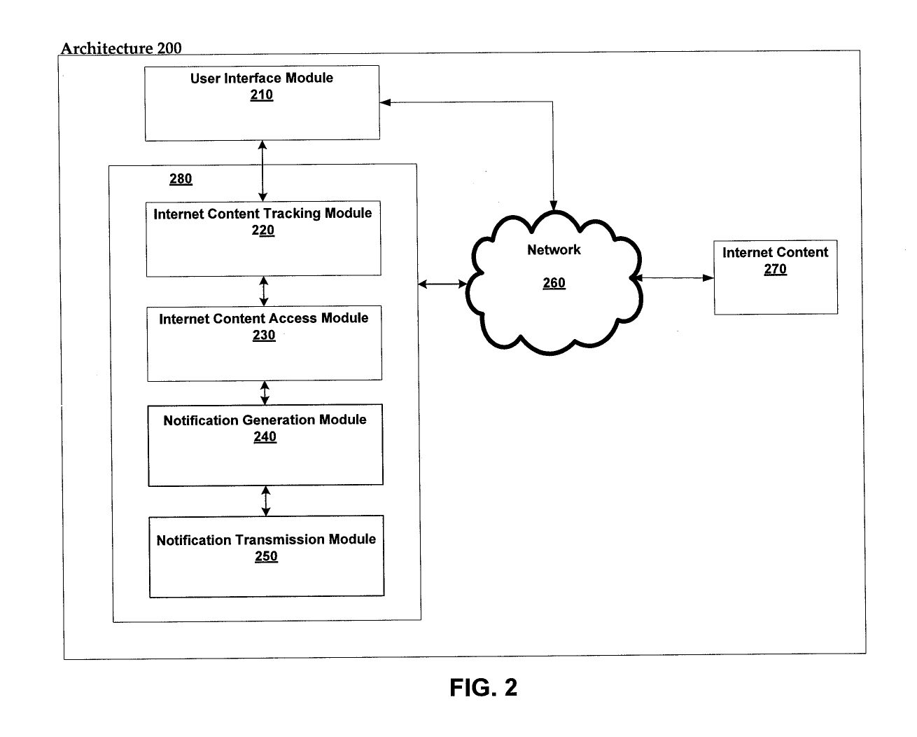

FIG. 2 illustrates an exemplary architecture 200 of an exemplary system for a notification policy application. The architecture 200 includes a user interface module 210, an Internet content tracking module 220, an Internet content access module 230, a notification generation module 240, a notification transmission module 250, a network 260, and an Internet content 270. Alternative embodiments may comprise more, less, or functionally equivalent modules. It will be appreciated by one of ordinary skill that examples of non-transitory computer readable storage media may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

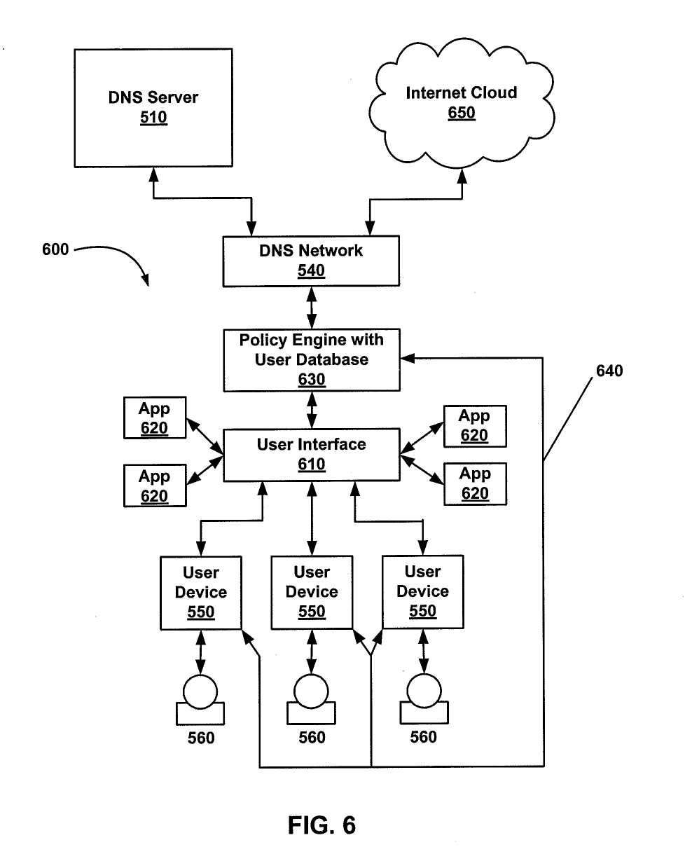

The user interface module 210 provides one or more user interfaces to the end user as a result of the notification policy application. The user interface module 210 provides, for instance, a user interface between the end user and the Internet service, so that communications between the two are enabled. Exemplary user interfaces provided by the user interface module 210 are shown in FIGS. 5 and 6.

The Internet content tracking module 220 may perform a step of receiving information related to Internet content (such as in the step 110 of the method 100 described earlier herein in relation to FIG. 1). The Internet content access module 230 may perform a step of determining whether an end user has accessed a monitored Internet content (such as the step 120 of the method 100 described earlier herein in relation to FIG. 1). The notification generation module 240 may perform a step of generating a notification (such as the step 130 of the method 100 described earlier herein in relation to FIG. 1). The notification transmission module 250 may perform a step of transmitting the notification to the end user (such as the step 140 of the method 100 described earlier herein in relation to FIG. 1). Modules 220, 230, 240, and 250 may be considered to constitute an Internet mediation system 280. After provisioning the Internet service the Internet mediation system 280 may communicate directly with the network 260.

The architecture 200 includes a network 260 which may comprise a DNS server. The network 260 may also include any type and number of databases, servers, end users, computing devices, and policy engines. The one or more Internet content being monitored is shown as Internet content 270. It will be appreciated by one skilled in the art that the system in FIG. 2 may be merged with or used in conjunction with any of the other exemplary systems described herein, including but not limited to the systems shown in FIGS. 5, 6, and 7. Furthermore, any of the optional steps described in method 100 of FIG. 1 may be performed by or in conjunction with one or more modules depicted in FIG. 2.

One or more of the modules described above may be used to gather and record data relative to Internet content accessed and attempts to access Internet content. Data collected may include addresses accessed and attempted to be accessed, number of times visited, duration of visit, whether other links are accessed from the site, etc. The data may be used to “learn” the search patterns of one or more users of the system. The system may then modify the mediation policy according to the learned history of use.

The system may also track various access characteristics to attempt to determine what kind of access was initiated. A beacon or similar tracking tool may be used to determine the amount of time spent by a user on a given site, whether the user clicks on links in the given site, etc. Tracking algorithms may then use the collected data to determine the nature of the site access. For example, the tracking algorithm may indicate whether or not the access of the site was intentional or inadvertent.

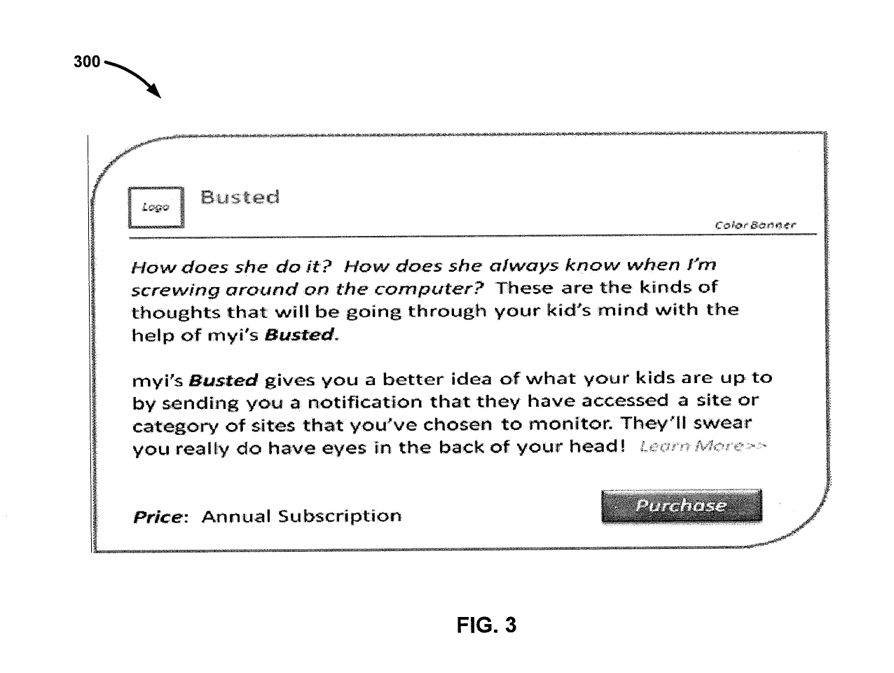

FIG. 3 is an exemplary screenshot of a user interface 300 that may be presented to an end user. The exemplary screenshot 300 provides a written summary of a notification policy application. Such a notification policy application may implement one or more methods described herein. The end user may click or otherwise actuate a “Learn More” link which will provide more information about the notification policy application beyond the initial summary provided to the end user. The end user may purchase access to the notification policy application by clicking or otherwise actuating the “Purchase” button. Following the purchase of the notification policy application, the end user may be provided an opportunity to download the notification policy application onto their user device.

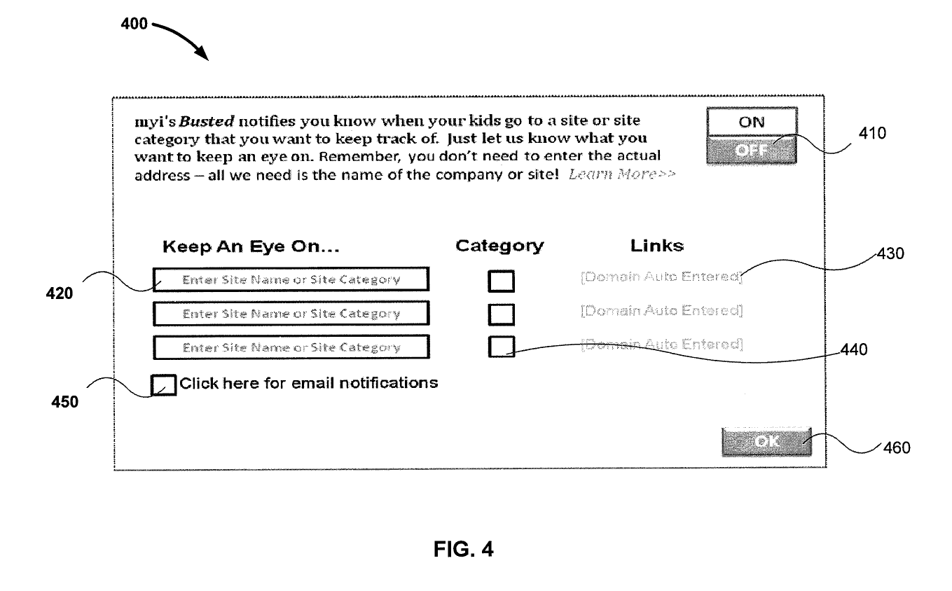

FIG. 4 is an exemplary screenshot of a user interface 400 for providing notifications regarding Internet access. The user interface 400 may be displayed to an end user as part of a notification policy application. The user interface 400 may comprise a configuration drawer. According to various embodiments, a first end user may utilize the user interface 400 to set configurations of the notification policy application. An optional summary of the notification policy application may be provided in the exemplary user interface 400. As shown in FIG. 4, the user interface 400 may include an On/Off button set 410, one or more information fields 420, one or more domain links 430, and one or more category buttons 440. The user interface 400 may also include an email notification button 450 and an OK button 460.

A listing of information fields 420, domain link fields 430 and category buttons 440 may be provided in a monitoring list to the end user. An information field 420 may be associated with a domain link field 430 and a category button 440. For instance, as depicted in FIG. 4, the information field 420, the domain link field 430 and the category button 440 listed across in a given row may be associated with one another. However, it will be appreciated by those skilled in the art that any number of configurations showing the associations of an information field, a domain link field and a category button may be depicted in the user interface 400.

The one or more information fields 420 are fields by which an end user may enter information regarding Internet content. As previously described, information regarding the Internet content may include a company name associated with the Internet content, a site name associated with the Internet content, a category name associated with the Internet content, or any combination thereof. An end user may input Internet content, use content created by other users of the Internet service, and/or designate a category they want to be monitored in the one or more information fields 420. The category may be an Internet content category or a category associated to one or more Internet content. Such categorized Internet content may be preloaded or otherwise stored as part of the notification policy application.

After an first end user has entered their selections into the one or more information fields 420, the notification policy application may auto-populate one or more domain link fields 430 with the actual URL address of the Internet content that the end user wants to monitor or with a URL of an Internet content associated with an Internet content category provided by the end user in the information field 420. The Internet service may determine Internet content that is associated or is most closely related to a first end user's request provided in the information field 420. If there is no check or selection of the category button 440 associated with a given domain link, then the domain link field 430 may provide the actual URL of a specified Internet content based on the information of the Internet content provided in the filled-in information field 420. On the other hand, if the Internet service has determined Internet content that is associated with or is most closely related to a first end user's request provided in the information field 420, and a URL of the determined Internet content is provided in the domain link in response to the end user's request, then the category button 440 associated with a domain link will be checked or otherwise selected. If the determination of an Internet content based on a first end user's request in the form of a category name is incorrect, a first end user may click on the domain link field 430 to activate a drop-down menu that provides other suggested Internet content that are related to the category. The first end user may select Internet content from the drop-down menu. A URL to the selected Internet content from the drop-down menu will appear in the domain link field 430.

First end users may repeat the process of populating the domain link fields 430 until all of their selections have been furnished to the information fields 420. Once all the selections of a first end user have been furnished, the initiating end user may click on or otherwise actuate the OK button 460 to have their notification settings saved and stored for future use. Once the OK button 460 has been selected, the configuration drawer interface 400 appears to close. To activate the functionality of the notification policy application, a first end user may select, click or otherwise actuate the On button of the On/Off button set 410. If a first end user inputs their notification settings but does not enable the notification policy application by selecting the On button, then an overlay may appear to the first end user asking if the first end user would like to enable the service prior to closing the configuration drawer. In some embodiments, the default setting for the notification policy application is “On.” If the first end user wishes to disable the functionality of the notification policy application, the first end user may select the Off button of the On/Off button set 410. If a first end user wishes to receive email notifications when an Internet content being monitored is accessed, the first end user may click on the email notification button 450. As described earlier herein, a notification may include the identification of the Internet content that was accessed, as well as the date and time it was accessed.

The systems and methods described above may typically be resident in an Internet service, a DNS server, or a DNS network. The systems and methods described may also be implemented in plug-in utilities, gateway devices, cable modems, proxy servers, set top boxes, and network interface devices.

Internet content records may also include Internet content collaboratively determined by a group of end users invited by the administrator to collaborate on the establishment of the Internet content records used in the mediation policy. The administrator may, before or after the administrator creates the administrator's own mediation policy, invite the administrator's family members, friends, colleagues or any group of combination of groups and individuals to identify appropriate Internet content to be used by the administrator in creating the administrator's own mediation policy. These invitees may or may not be users of the Internet service but will be allowed to contribute to the administrator's mediation policy via the user interface of the Internet service. The administrator may choose to moderate the contributions of individuals or groups invited by the administrator to contribute to the administrator's mediation policy. The administrator may also, before or after the administrator creates the administrator's own mediation policy, join an existing group of users of the Internet service and apply the determinations of appropriate Internet content by a group to the administrator's own mediation policy. Where there is an existing group that the administrator joins for purposes of creating a mediation policy, the administrator may choose to import the contributions of other groups once or subscribe to these groups to reduce the configuration burden of creating a mediation policy. After the administrator creates the administrator's own mediation policy, the administrator may publish the administrator's mediation policy to be used and/or subscribed to by other users of the Internet service. In such case, other users of the Internet service may import the contributions of administrator once or subscribe to the administrator's mediation policy for use in their own mediation policies. It is understood that via this collaboration two or more user-administrators may combine their mediation policies to create one mediation policy that may be used by these and other administrators of the Internet service.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS 510 level. The content rules are applied to received user queries, and determine the content that is delivered by the DNS network 540 through various user devices 550 to the end users 560.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, notebooks, gaming devices, music players, Smartphones, automobile computer systems, and Internet enabled TVs. The system 600 may also be accessed and controlled remotely through user devices 550, such as a Smartphone. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing Smartphones as the user device 550, the policy applications 620 are downloaded to the device 550. The device 550 then serves as the user interface 610 to communicate directly with the dynamic policy engine 630.

The policy applications 620 may prohibit access to specific sites. The policy applications 620 may also limit the time of day when users or selected users 560 may access certain sites. The policy applications 620 may also manage and analyze duration of access to various sites. It is important to note that the policy applications 620 do not simply provide blocking mechanisms by masking or enabling network controls, but rather mediate an Internet service received by the end user. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when sites are accessed. The policy applications 620 may also provide notification of frequency and duration of access of designated sites. The policy applications 620 may also be used to observe, substitute, enable, redirect users, to reward behavior desired from the users by a system administrator, etc. The policy applications 620 may redirect users from a non-favored site to another site. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

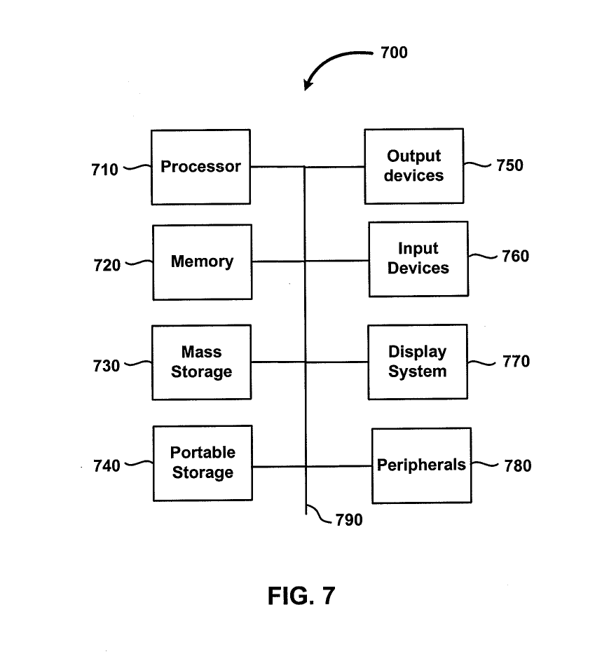

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” encompasses any content that may be accessed by an user device including but not limited to one or more of web sites, domains, web pages, web addresses, hyperlinks, URLs, any text, pictures, and/or media (such as video, audio, and any combination of audio and video) provided or displayed on a web page, and any combination thereof. Mediating the Internet service may include any of blocking, constraining, enabling, redirecting, promoting, demoting, substituting, obscuring, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for providing user defined notifications regarding Internet access, the method comprising:
receiving monitoring criteria for Internet content by an Internet service via a user interface between an first end user and the Internet service;
determining whether the Internet content has been accessed or used by a second end user, the determination performed by the Internet service;
generating a notification when the Internet content has been accessed or used by the second end user; and
transmitting the generated notification via the user interface to the first end user.

2. The method of claim 1, wherein the Internet content to be monitored is associated with a category.

3. The method of claim 1, wherein the Internet content to be monitored is associated with at least one specific Internet site.

4. The method of claim 1, wherein the Internet content to be monitored is contained on a monitoring list generated by the Internet service or third parties.

5. The method of claim 1, wherein the Internet content to be monitored is contained on a monitoring list created by the first user or produced by groups of users of the Internet service.

6. The method of claim 1, wherein the method further comprises storing in memory the received information regarding the Internet content.

7. The method of claim 1, wherein a DNS server initiates a request that is then further processed by the Internet service.

8. The method of claim 1, wherein the Internet service differentiates between intentional and inadvertent access to Internet content.

9. The method of claim 2, wherein the method further comprises determining further whether the Internet content is associated with a content category designated by the first end user.

10. The method of claim 2, wherein determining whether the Internet content has been used by the second end user further comprises receiving access information regarding the Internet content from a third party.

11. The method of claim 2, wherein the method further comprises pre-populating a monitoring list with Internet content associated with the category, the monitoring list displayed on a user interface provided to the first end user.

12. The method of claim 11, wherein the method further compromises multiple end users participating to define categories.

13. The method of claim 10, wherein the method further comprises receiving and implementing feedback regarding the monitoring list from the initiating user.

14. The method of claim 1, wherein the method further comprises applying policies of a notification policy application to the Internet service.

15. The method of claim 13, wherein applying the policies of the notification policy application comprises dynamically logging and reporting access of the Internet content performed by the Internet service.

16. The method of claim 1, wherein information received regarding the Internet content comprises a company name associated with the Internet content, a site name associated with the Internet content, or a category name associated with the Internet content.

17. The method of claim 1, wherein the information received regarding the access and use of the Internet content is configured for transmitting, sharing or publishing to a party at the discretion of the first end user.

18. The method of claim 1, wherein determining whether the Internet content has been accessed by the second end user further comprises receiving from the Internet service a list of Internet content that are accessed by the second end user.

19. The method of claim 1, wherein determining whether Internet content has been accessed is automatically initiated upon occurrence of a pre-defined series of events without secondary processing by the Internet service.

20. The method of claim 1, further comprising transmitting the generated notification to any party.

21. The method of claim 1, wherein transmitting the generated notification via the user interface to the first end user further comprises transmitting the generated notification for display for the first end user.

22. The method of claim 1, wherein transmitting the generated notification via the user interface to the first end user further comprises transmitting the generated notification through push or pull technology, such as electronic messages, electronic mail or text messages to display for the first end user.

23. The method of claim 1, wherein a history of all notifications is stored and is accessible for processing, analysis, or reporting.

24. The method of method 1, wherein a history of all access to Internet content is stored and is accessible for processing, analysis, or reporting.

25. The method of claim 1, wherein at least one element of the monitoring criteria is resident on a DNS server.

26. The method of claim 1, wherein the monitoring criteria is at least in part enforced by a DNS server.

27. The method of claim 1, wherein the administrator specifies different monitoring criteria for different locations.

28. The method of claim 1, wherein at least one element of the Internet service resides on a user device.

29. The method of claim 1, wherein the monitoring criteria are created by a collaborative effort from more than one user.

30. The method of claim 29, wherein at least one user is not a user of the network to which the monitoring criteria is applied.

31. A system for providing notifications regarding Internet access, the system comprising:
a user interface between an first end user and an Internet service to specify what Internet content to monitor;
the Internet service determining whether the Internet content has been accessed by a second end user; and
a processor for executing the instructions stored in memory to:
generate a notification when the Internet content has been accessed by the second end user, and
transmit the generated notification via the user interface to the first end user.

32. The system of claim 31, wherein the Internet content is associated with a category.

33. The system of claim 31, wherein the Internet content is associated with an Internet site.

34. The system of claim 31, wherein the Internet content to be monitored is contained in a monitoring list generated by the Internet service or third parties.

35. The system of claim 31, wherein the Internet content to be monitored is contained in a monitoring list created by the first user or by groups of users of the Internet service.

36. The system of claim 31, wherein executing instructions stored in memory by the processor to determine whether the Internet content has been accessed by the second end user requires retrieving access information stored in a DNS server.

37. The system of claim 31, wherein the system further comprises a DNS server initiating a query to the Internet service to determine whether the access attempt should be logged and recorded.

38. The system of claim 31, wherein the system further comprises pre-populating a monitoring list with Internet content associated with the category, the monitoring list displayed on a user interface provided to the first end user.

39. The system of claim 31, wherein the system further compromises a monitoring list created by various otherwise unrelated end users of the Internet service.

40. The system of claim 31, wherein the system further comprises receiving and implementing feedback regarding the monitoring list from the first end user.

41. The system of claim 31, wherein the system further comprises applying policies of a notification policy application to the Internet service.

42. The system of claim 41, wherein applying the policies of the notification policy application comprises dynamically logging and reporting Internet access of the Internet content performed by the Internet service.

43. The system of claim 31, wherein the information received regarding the Internet content comprises a company name associated with the Internet content, a name associated with the Internet content, or a category name associated with the Internet content.

44. The system of claim 31, wherein the information received regarding the Internet content is configured for transmitting, sharing or publishing to a third party at the discretion of the first end user.

45. The system of claim 31, wherein determining whether the Internet content has been accessed by the second end user further comprises receiving from the Internet service a list of Internet content that are accessed by the second end user.

46. The system of claim 31, wherein determining whether Internet content has been accessed is automatically generated without secondary processing by the Internet service if a series of events occurs.

47. The system of claim 31, further comprising transmitting the generated notification to a third party.

48. The system of claim 31, wherein transmitting the generated notification via the user interface to the first end user further comprises transmitting the generated notification for display on the first end user.

49. The system of claim 31, wherein transmitting the generated notification via the user interface to the first end user further comprises transmitting the generated notification through push or pull technology, such as electronic messages, electronic mail, or text messages to display to the first end user.

50. The system of claim 31, wherein a history of all notifications is stored and is accessible for processing and analysis.

51. The system of claim 31, wherein a history of all access to Internet content is stored and is accessible for processing and analysis.

52. The system of claim 31, further comprising determining whether the Internet content is associated with a content category designated by the initiating user.

53. The system of claim 31, wherein the Internet service differentiates between intentional and inadvertent access to Internet content.

54. The system of claim 31, wherein the administrator specifies different monitoring policies for different locations.

55. The system of claim 31, wherein at least one element of the Internet service reside on a user device.

56. The system of claim 31, wherein the mediation policy is created by a collaborative effort from more than one user.

57. The system of claim 56, wherein at least one user is not a user of the network to which the mediation policy is applied.

58. A non-transitory computer-readable storage medium having embodied thereon a program, the program executable by a processor in a computing device to perform a method for providing notifications, the method comprising:
receiving information regarding an Internet content by an Internet service provider via a user interface between a first end user and the Internet service provider;
determining whether the Internet content has been accessed by a second end user, the determination performed by the Internet service provider;
generating a notification when the Internet content has been accessed by the second end user; and
transmitting the generated notification via the user interface to the first end user.

59. A method for generating a user interface to set a notification policy application regarding Internet access, the method comprising:
generating an information field for receiving information regarding an Internet content, wherein the received information comprises either an identification of a specified Internet content or a category name of Internet content;
generating a domain link field associated with the information field, the domain link field providing at least one domain link, the at least one domain link displaying a URL link to the Internet content as provided by an Internet service provider; and
generating a category button associated with the domain link field, the category button selected when the domain link field provides the at least one domain link to a category of Internet content based on the category name provided in the information field.

60. The method of claim 59, wherein the information regarding the Internet content comprises a company name associated with the Internet content, a name associated with the Internet content, or a category name associated with the Internet content.

61. A method for providing notifications regarding Internet access, the method comprising:
receiving information regarding an Internet content via a user interface between a first end user and the Internet service;
determining whether the Internet content has been accessed by a second end user, determining being performed by a DNS server;
generating a notification when the Internet content has been accessed by the second end user; and
transmitting the generated notification via the user interface to the first end user.

62. The method of claim 61, wherein the Internet content is associated with a category.

63. The method of claim 61, wherein the Internet content is associated with an Internet site.

64. The method of claim 61, wherein determining whether the Internet content has been accessed by the second end user further comprises receiving access information regarding the Internet content from a the DNS server.

65. The method of claim 61, wherein the method further comprises storing the received information regarding the Internet content in the DNS server.

66. The method of claim 62, wherein the method further comprises determining further Internet content associated with the category.

67. The method of claim 62, wherein the method further comprises pre-populating a monitoring list in the DNS server with Internet content associated with the category, the monitoring list displayed on a user interface provided to the first end user.

68. The method of claim 67, wherein the method further comprises receiving and implementing feedback regarding the monitoring list from the first end user.

69. The method of claim 61 wherein the method further compromises multiple end users participating to define categories.

70. The method of claim 61, wherein the DNS server initiates a request that is then further processed by the Internet service.

71. The method of claim 61, wherein the method further comprises applying policies of a notification policy application to the Internet service.

72. The method of claim 71, wherein applying the policies of the notification policy application comprises dynamically logging and reporting access of Internet content ascertained by the DNS server.

73. The method of claim 61, wherein information received regarding the Internet content comprises a company name associated with the Internet content, a site name associated with the Internet content, or a category name associated with the Internet content.

74. The method of claim 61, wherein the information received regarding the Internet content is configured for transmitting, sharing or publishing to a third party at the discretion of the first end user.

75. The method of claim 61, wherein determining whether the Internet content has been accessed by the second end user further comprises receiving from the DNS server a list of Internet content that has been accessed by the second end user.

76. The method of claim 61, wherein determining whether Internet content has been accessed is automatically generated without secondary processing by the DNS server if a series of events occurs.

77. The method of claim 61, further comprising transmitting the generated notification to a third party.

78. The method of claim 61, wherein transmitting the generated notification via the user interface to the first end user further comprises transmitting the generated notification for display for the first end user.

79. The method of claim 61, wherein transmitting the generated notification via the user interface to the first end user further comprises transmitting the generated notification through push technology or pull electronic messages such as mail or text to display for the first end user.

80. The method of claim 61, wherein a history of all notifications is stored and is accessible for processing and analysis.

81. The method of claim 61, wherein a history of all access to Internet content is stored and is accessible for processing and analysis.

82. The method of claim 61, wherein the Internet content to be monitored is contained on a monitoring list created by the first end user or produced by groups of users of the Internet service.

83. The method of claim 61, further comprising determining whether the Internet content is associated with a content category designated by the first end user.

84. The method of claim 61, wherein the Internet service differentiates between intentional and inadvertent access to Internet content.

85. A system for providing notifications regarding Internet access, the system comprising:
a user interface between a first end user and an Internet service to receive information regarding an Internet content;
a DNS server for initiating a determination of whether the Internet content has been accessed by a second end user; and
a processor for executing the instructions stored in memory to:
generate a notification when the Internet content has been accessed by the second end user, and
transmit the generated notification via the user interface to the first end user.

86. The system of claim 85, wherein the Internet content is associated with a category.

87. The system of claim 85, wherein the Internet content is associated with an Internet site.

88. The system of claim 85, wherein executing instructions stored in memory by the processor to determine whether the Internet content has been accessed by the second end user further comprises receiving access information regarding the Internet content from a third party.

89. The system of claim 85, wherein the method further comprises storing the received information regarding the Internet content in memory.

90. The system of claim 85, wherein the method further comprises pre-populating a monitoring list with Internet content associated with the category, the monitoring list displayed on a user interface provided to the first end user.

91. The system of claim 85, wherein the DNS server initiates a request that is then further processed by the Internet service.

92. The system of claim 85, wherein the method further compromises multiple end users participating to define categories.

93. The system of claim 85, wherein the method further comprises receiving and implementing feedback regarding the monitoring list from the first end user.

94. The system of claim 85, wherein the method further comprises applying policies of a notification policy application to the Internet service provider.

95. The system of claim 94, wherein applying the policies of the notification policy application comprises dynamically logging and reporting Internet access of the Internet content performed by the DNS server.

96. The system of claim 85, wherein the information received regarding the Internet content comprises a company name associated with the Internet content, a name associated with the Internet content, or a category name associated with the Internet content.

97. The system of claim 85, wherein the information received regarding the Internet content is configured for transmitting, sharing or publishing to a third party at the discretion of the first end user.

98. The system of claim 85, wherein determining whether the Internet content has been accessed by the second end user further comprises receiving from the DNS server a list of Internet content that are accessed by the second end user.

99. The system of claim 85, wherein determining whether Internet content has been accessed is automatically generated without secondary processing by the DNS server if a series of events occurs.

100. The system of claim 85, further comprising transmitting the generated notification to a third party.

101. The system of claim 85, wherein transmitting the generated notification via the user interface to the first end user further comprises transmitting the generated notification for display on the first end user.

102. The system of claim 85, wherein transmitting the generated notification via the user interface to the first end user further comprises transmitting the generated notification through push or pull technology, such as electronic messages, electronic mail, or text messages to display to the first end user.

103. The system of claim 85, wherein a history of all notifications is stored and is accessible for processing and analysis.

104. The system of claim 85, wherein a history of all access to Internet content is stored and is accessible for processing and analysis.

105. The system of claim 85, further comprising determining whether the Internet content is associated with a content category designated by the first end user.

106. The system of claim 65, wherein the Internet service differentiates between intentional and inadvertent access to Internet content.

107. A non-transitory computer-readable storage medium having embodied thereon a program, the program executable by a processor in a computing device to perform a method for providing notifications, the method comprising:
receiving information regarding an Internet content by a DNS server via a user interface between a first end user and an Internet service, the DNS server being coupled with the Internet service;
determining whether the Internet content has been accessed by a second end user, the determination initiated by the DNS server;
generating a notification when the Internet content has been accessed by the second end user; and
transmitting the generated notification via the user interface to the first end user.

108. A method for generating a user interface to set a notification policy application regarding Internet access, the method comprising:
generating an information field for receiving information regarding an Internet content, wherein the received information comprises either an identification of a specified Internet content or a category name of Internet content;
generating a domain link field associated with the information field, the domain link field providing at least one domain link, the at least one domain link displaying a URL link to the Internet content as provided by a DNS server; and
generating a category button associated with the domain link field, the category button selected when the domain link field provides the at least one domain link to a category of Internet content based on the category name provided in the information field.

109. The method of claim 81, wherein the information regarding the Internet content comprises a company name associated with the Internet content, a name associated with the Internet content, or a category name associated with the Internet content.
